(19) United States
(12) Patent Application Publication
(10) Pub. No.: US 2024/0176911 A1
(43) Pub. Date: May 30, 2024

(54) DEVICE CERTIFICATION BASED ON DEVICE CAPABILITIES

(71) Applicant: MASTERCARD INTERNATIONAL INCORPORATED, New York, NY (US)

(72) Inventors: Vladimir MAMUT, Jewett, NY (US); Tarun BAFNA, Rajgarh (Dhar) (IN); Andreas George Koutsoudis, London (GB)

(73) Assignee: MASTERCARD INTERNATIONAL INCORPORATED, New York, NY (US)

(21) Appl. No.: 18/070,101

(22) Filed: Nov. 28, 2022

(51) Int. Cl. G06F 21/64

(52) U.S. Cl. CPC G06F 21/64

(57) ABSTRACT

Systems and methods are described for specifying capability requirements and/or performance criteria, generating a device certification profile, conducting a test based on the device certification profile, and generating a device certificate based on the test. Applications on the device may use the device certificate to enable or disable various functions that access a service that may require a device to have certain capability requirements and/or performance criteria.

### BACKGROUND

Computing devices may be manufactured to include a component such as hardware or software with varying degrees of performance. For example, one model of a computing device may include a processor or other hardware that outperforms another model of the computing device from the same or different manufacturer. Computing devices may also be manufactured with different components altogether. For example, one model of a computing device may include a biometric sensor such as a fingerprint reader while another model may not. The difference in hardware and/or software is largely driven by manufacturing costs and target consumers. Regardless of the reason for the difference, one issue that may result is that different models of devices may have different capabilities.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system of certifying a device to enable services available to the device;

FIG. 2 illustrates an example operation of the system in various phases;

FIG. 3 illustrates an example of an implementation of the system in which platform services are provided via point of interaction (POI) devices;

FIG. 4 illustrates an example of a method of certifying a device and accessing platform services based on a device certificate;

FIG. 5 illustrates an example of a method of configuring certificate criteria;

FIG. 6 illustrates an example of a method of setting up a device under certification for testing;

FIG. 7 illustrates an example of a method of testing the device under certification;

FIG. 8 illustrates an example of a method of certifying the device and generating a device certificate;

FIG. 9 illustrates an example of a method of verifying device capabilities based on the device certificate;

FIG. 10 illustrates an example of a method of testing onboard hardware using performance metrics for a device under certification;

FIG. 11 illustrates an example of a method of accessing services based on a device certificate;

FIG. 12 illustrates an example of a method of certifying a device;

FIG. 13 illustrates an example of a method of generating a device certificate; and

FIG. 14 illustrates an example of a computer system that may be implemented by devices illustrated in FIGS. 1 and 3.

### DETAILED DESCRIPTION

The disclosure relates to methods and systems of automatically testing device capabilities, issuing device certificates based on the testing, and using the device certificate to enable access to services available to the device. Some services may require that a device has certain capabilities, such as hardware and/or software capabilities, in order to access the service. For example, a service may require user authentication. As such, a capability requirement may include a requirement that a device has a biometric sensor to authenticate the user. In another example, the service may require that the device is able to communicate with another device using near-field communication (NFC) or other communication protocol. In some examples, the service may require that the device meet certain performance criteria. For example, the service may require that the device is able to perform a sample computation or task within a specified duration of time. In another example, the service may require that the device is able to generate an image with a minimum resolution quality. In some instances, the service may require a combination of device capabilities and performance. For example, the service may require that the device has a biometric sensor that is able to authenticate users with a maximum error rate. The service may require other capabilities and/or performance criteria.

One issue with the vast array of available models and types of devices is that they may have different capabilities and/or performance. This may be particularly problematic in a “bring your own device” (“BYOD”) implementation in which users may be free to use their own devices instead of devices issued to them by an organization to interact with these services. To address these and other issues, a system may be improved to specify capability requirements and/or performance criteria, generate a device certification profile, conduct a test based on the device certification profile, and generate a device certificate based on the test. Applications on the device may use the device certificate to enable or disable various functions that access the services. Thus, a device may be certified to access a service based on the capability requirements and/or performance criteria specified by the service and the device certificate, which indicates a result of capabilities and/or performance testing.

An administrator of a platform service may configure various criteria that may be required for using the platform service. This configuration defines the available device capabilities against the objectives of the platform service. For example, an administrator (“admin”) user may configure capability requirements and/or performance criteria thresholds for various operations (such as biometric performance, card taps, and so forth) that are required in a platform application of the device. A device certification system may receive the capability requirements and/or performance criteria and generate a device certification profile.

To test the device, a certification application is installed on the device. The certification application downloads the device certification profile from the device certification system and executes a test of the device capabilities and/or performance benchmarks against the device certification profile. The certification application may transmit a device parameter and a result of the test to the device certification system, which analyzes the results and generates a device certificate. The device parameter may include a model of the device, a manufacturer of the device, device identifying information, and/or other information that describes the device. The device certification system may digitally sign the device certificate and store the device certificate and/or the digitally signed device certificate. The device certificate may be stored in association with the device parameter for later retrieval.

A platform application may be installed at the device. For example, a user of the device may download and execute (launch) the platform application. The platform application may identify a device make and model (and/or other device parameter) and download the corresponding device certificate from the device certification system. For example, a given device certificate may correspond to a device's make and model. It should be noted that the device may be the same device that was tested to generate the device certificate or may be another device that is the same model (or other device parameter) as a device that was previously tested.

The platform application may store the downloaded device certificate locally at the device to be evaluated to determine whether the device is certified to access various platform services. The platform application may enable or disable functions of the platform application based on the device certificate. If the device certificate is stored locally, the platform application may enable or disable functions of the platform application locally without a network connection. In these examples, the device may enable the functions even when a network connection is unavailable.

It should be noted that a device re-certification may be initiated upon an occurrence of a re-certification triggering condition. The re-certification triggering condition may include a change to the device profile (such as when new software or an updated version of the model is available), changes to a device certification profile, and/or other changes since a prior certification that may trigger a re-certification of the device. The re-certification may include the same test or a different test depending on whether the device certification profile (the device capabilities requirements and/or performance criteria) has changed. Thus, in some examples, the platform application may check whether any re-certification triggering conditions have been met. If so, the platform application may download an updated device certification profile if necessary and initiate a recertification via the certification application.

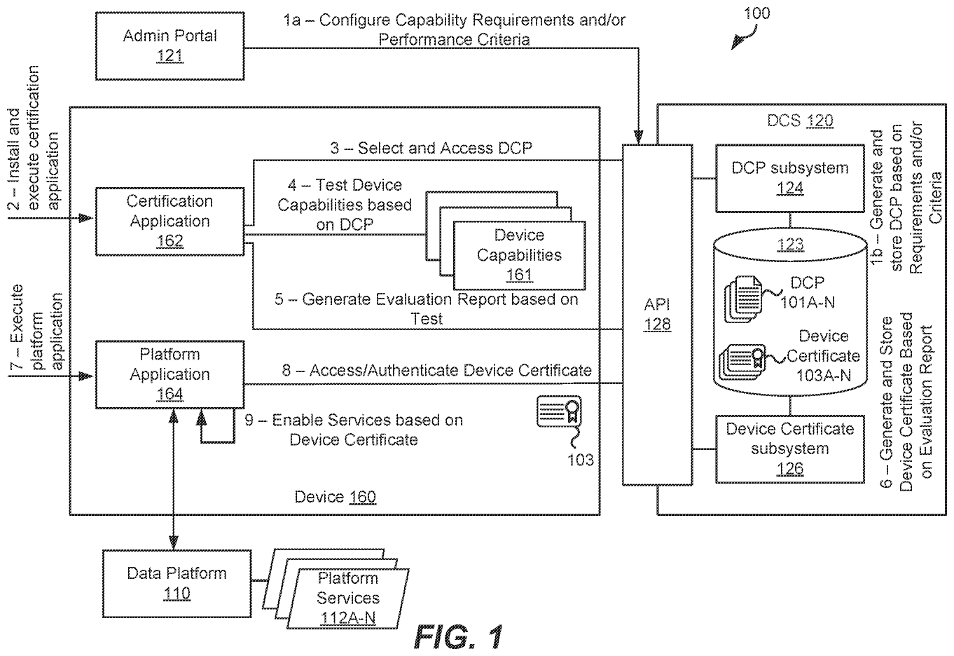

FIG. 1 illustrates an example of a system 100 of certifying a device 160 to enable services available to the device. The system 100 may include a data platform 110, a device certification system (DCS) 120, a device 160, and/or other features. The data platform 110 may provide one or more platform services 112 that may be accessible to the device 160 depending on whether the device 160 has been certified to access those services. A platform service 112 may refer to functionality provided by the data platform 110. Examples of functionality include user identification services, fund transfers, account lookups, data transmission, data storage, database access functions, network access functions, and/or other functionality that may be facilitated by the data platform 110. A platform service 112 may be accessed by the device 160 via hardware or programming on the device 160 that interfaces with the platform service 112. One example of a data platform 110 that may be used is described in U.S. patent application Ser. No. 17/473,589, entitled “MULTI-WALLET COMMUNITY SERVICES WITH INTEGRATED PAYMENT SERVICES”, filed on Sep. 13, 2020, which is incorporated by reference in its entirety herein for all purposes.

The DCS 120 may include an admin portal 121, a datastore 123, a DCP subsystem 124, a device certificate subsystem 126, an Application Programming Interface (API) 128, and/or other features. The admin portal 121 may include an interface for interacting with the DCS 120. The DCP subsystem 124 may generate device certification profiles (DCPs) 101A-N. A DCP 101 may refer to electronic data that includes one or more device capability requirements and/or performance criteria. The device certificate subsystem 126 may generate device certificates 103A-N. A device certificate 103 may refer to electronic data that indicates a result of testing a device based on a DCP 101. The DCP subsystem 124 and the device certificate subsystem 126 may each include hardware and/or software of the DCS 120 to perform their respective functionalities described herein. A DCP 101 and/or a device certificate 103 may be encoded as an electronic file that can be transmitted and/or stored. The API 128 may expose a programming interface to the DCP subsystem 124 and/or the device certificate subsystem 126. For example, the API 128 may receive API calls from the admin portal 121, the device 160, and/or other components to communicate with the DCP subsystem 124, the device certificate subsystem 126, and/or other feature of the DCS 120.

A device 160 may include a certification application 162, a platform application 164, and/or other features. The certification application 162 may test capabilities and/or performance of one or more of the device capabilities 161. Device capabilities 161 may refer to hardware, software, and/or other functions or features that the device 160 includes or has access to. The certification application 162 may test the device 160 based on the requirements and/or criteria specified in a DCP 101. A device 160 being tested may be referred to as a “device under certification” or “DUC.” Based on a result of the testing, a device certificate 103 may be assigned to the device 160. In some examples, the device certificate 103 may be parameter-specific. In these examples, a device certificate 103 for a device 160 may be applicable to other devices having the same model parameters. In a particular example, the device certificate 103 may be model-specific. In this example, a device certificate 103 for a device 160 may be applicable to other devices of the same model that was tested. The platform application 164 may execute on the device 160 to provide one or more functions, which may be associated with platform services 112.

The platform application 164 may enable platform services 112 based on the device certificate 103. For example, a platform service 122 may require that the device 160 perform biometric authentication in order to proceed with the platform service 122. If the device certificate 103 is not available or is available but does not indicate that the device 160 is capable of performing biometric authentication, then the platform application 164 may not enable a function that provides access to the platform service 122. On the other hand, if the device certificate 103 indicates that the device 160 is capable of performing biometric authentication, then the device 160 enable the function to access the platform service 122. A function in this sense may refer to computational logic or operation that provides a processing result such as use of the platform service 122. A first device having a first set of capabilities and/or performance may access different platform services 122 than a second device having a second, different, set of capabilities.

Having described a high level overview of the system 100, an example data flow in the system 100 will now be described. The operations of the data flow are numbered for convenience of illustration. Some numbered operations may be omitted or re-arranged and other operations may be added. At 1a, an admin user may use the admin portal 121 to input one or more capability requirements and/or one or more performance criteria. For example, the admin user may define the capability requirements and/or one or more performance criteria to ensure that a device is capable of providing required functionality to access a given platform service 112. Examples of device capability requirements and performance criteria are shown in Table 1 below for illustration.

TABLE 1
Examples device capability requirements and performance criteria
are provided. It should be noted that the device capability
requirements and the performance criteria, though shown separate,
may be linked to one another. For example, the “biometric
sensor” device capability requirement may be associated
with “Authenticate the user using a biometric feature”
such that both are evaluated in connection with one another.

| Description | Type |
|---|---|
| Biometric Sensor | Device Capability Requirement |
| NFC capability | Device Capability Requirement |
| Minimum 1GB RAM | Device Capability Requirement |
| Minimum 2-core Processor | Device Capability Requirement |
| Must include support for specified | Device Capability Requirement |
| software utility | |
| Must have minimum specified OS | Device Capability Requirement |
| version | |
| . . . | . . . |
| Other description | Other Device Capability |
| | Requirement |
| Authenticate the user using a biometric | Performance Criteria |
| feature | |
| Authenticate the user using a biometric | Performance Criteria |
| feature having an error rate based on | |
| impostor and genuine comparison above | |
| threshold error (single-finger 95%; two- | |
| finger 98%; false positive rate 0.1%). | |
| Able to perform specified computation | Performance Criteria |
| within threshold period of time | |
| Perform NFC (or other) communication | Performance Criteria |
| with another device within specified | |
| time | |
| . . . | Performance Criteria |
| Other performance criteria | Performance Criteria |

At 1b, the DCP subsystem 124 may access the capability requirements and/or performance requirements from the admin portal 121, such as through an API call made from the admin portal 121 to the API 128. The DCP subsystem 124 may generate a DCP 101 based on the one or more capability requirements and/or one or more performance criteria. The DCP 101 may therefore include the one or more capability requirements and/or one or more performance criteria. The DCP subsystem 124 may also include, in the DCP 101, a DCP identifier (ID) that uniquely identifies the DCP 101, a DCP name that is a user-friendly name of the DCP 101, and/or other data associated with the creation of the DCP 101. The DCP subsystem 124 may store the DCP 101 in various formats. For example, the DCP subsystem 124 may store the DCP 101 in a data structure of a datastore 123. The DCP 101 may be retrieved from the datastore 123 via the DCP ID, DCP name, or other uniquely identifying information.

At 2, the device 160 may install and execute a certification application 162 that programs a processor of the device 160 to execute a certification test based on the DCP 101. For example, a user of the device 160 may download and start the certification application 162. At 3, the certification application 162 may request a listing of available DCPs 101, select a DCP 101, and access the selected DCP 101. For example, the certification application 162 may query the API 128 for available DCPs 101 and present the available DCPs 101 (DCP IDs, DCP names, and/or other identifying information) for selection. The user may then select the DCP 101. Alternatively, the certification application 162 may automatically select the DCP 101, such as based on platform applications 164 installed at the device 160. Regardless of the manner in which the DCP 101 is selected, the DCS 120 may provide query the datastore 123 for available DCPs 101 and transmit a listing back to the device 160. The DCS 120 may then provide a copy of the selected DCP 101 to the device 160. Some or all of the interactions between the DCS 120 and the device 160 may be made through the API 128.

At 4, the certification application 162 may execute a certification test based on the DCP 101. The test may assess one or more of the device capabilities 161 based on the capability requirements and/or performance criteria specified in the DCP 101. During the certification test, the certification application 162 may monitor or otherwise record performance of the device capabilities 161 (such as time to complete, storage memory usage, RAM usage, processor usage, image resolution, error rates of biometric sensor testing, and/or other performance metrics).

At 5, the certification application 162 may generate an evaluation report based on the test. The evaluation report may include the DCP identifier that identifies the DCP 101 used for test, the DCP name, device parameters such as model name, results of the test, testing date/time, and/or other data relating to the test. The result may include a processing time to complete a tested requirement or criteria, resource consumption to conduct the tested requirement or criteria, biometric capture quality, support for liveness detection during camera capture, and/or other monitored result. The result may include values such as a binary value (for example, pass/fail, 0/1), a continuous result such as a measured value like processing time or error rate, and/or other types of monitored results. The evaluation result may be formatted as a JSON file, XML, and/or output format. Once generated, the certification application 162 may transmit the evaluation report to the DCS 120.

At 6, the device certificate subsystem 126 may analyze the evaluation report and generate a device certificate 103 based on the evaluation report. In some examples, the device certificate 103 may include an indication of capability requirements and/or performance criteria and their corresponding result (regardless of whether passed/failed). In some examples, the device certificate 103 may include a listing of capability requirements and/or performance criteria that have been satisfied (only for those requirements and/criteria that have passed). The device certificate subsystem 126 may store the device certificate 103 in the datastore 123. The device certificate 103 may be stored in association with a device profile such as a model name and/or other device identifying information. For examples in which the device certificate 103 is stored in association with the model name, the device certificate 103 may be used for all devices that are the same model as the device that was certified/tested. In some examples, the device certificate 103 may be stored in association with the DCP ID, DCP name, and/or other DCP identifying information. Alternatively or additionally, the device certificate 103 may include the DCP ID, DCP name, and/or other DCP identifying information.

In some examples, the device certificate 103 may be digitally signed by the DCS 120. For example, the DCS 120 may digitally sign the device certificate 103 with a private key of the DCS 120. The private key may be generated along with a public key using asymmetric cryptography. For example, the public key-private key pair may be generated using the Rivest-Shamir-Adleman (RSA) algorithm, which creates a mathematically linked pair of keys. Digital signature using the private key may take as input the private key and the device certificate 103 to create a cryptographically generated output (the digitally signed device certificate 103) that may be decrypted using the public key. The device certificate subsystem 126 may keep the private key private while publishing the public key for devices 160 to cryptographically verify that the digital signature is authentic. It should be noted that the device certificate 103 may be stored in its digitally signed form or its non-digitally signed form.

At 7, a platform application 164 may be executed. For example, a user may initiate a platform application 164 on the device 160 that was tested by the certification application 162. At 8, the platform application 164 may access and authenticate a device certificate 103. For example, the platform application 164 may request and receive the device certificate 103 from the DCS 120. At 9, the platform application 164 may enable one or more platform services 112A-N for access by the device 160 based on the device certificate 103. For example, if a platform service 112 requires a biometric authentication to authenticate a user before proceeding and the device certificate 103 indicates that the device 160 satisfies this requirement, then the platform application 164 may enable the platform service 112 for access by the device 160. On the other hand, if the device certificate 103 does not indicate that the device 160 satisfies this requirement, then the platform application 164 may not enable the platform service 112 for access by the device 160. Other services may be similarly enabled based on the device certificate 103, which may be stored locally at the device 160 for later reference as well.

### Example Operation

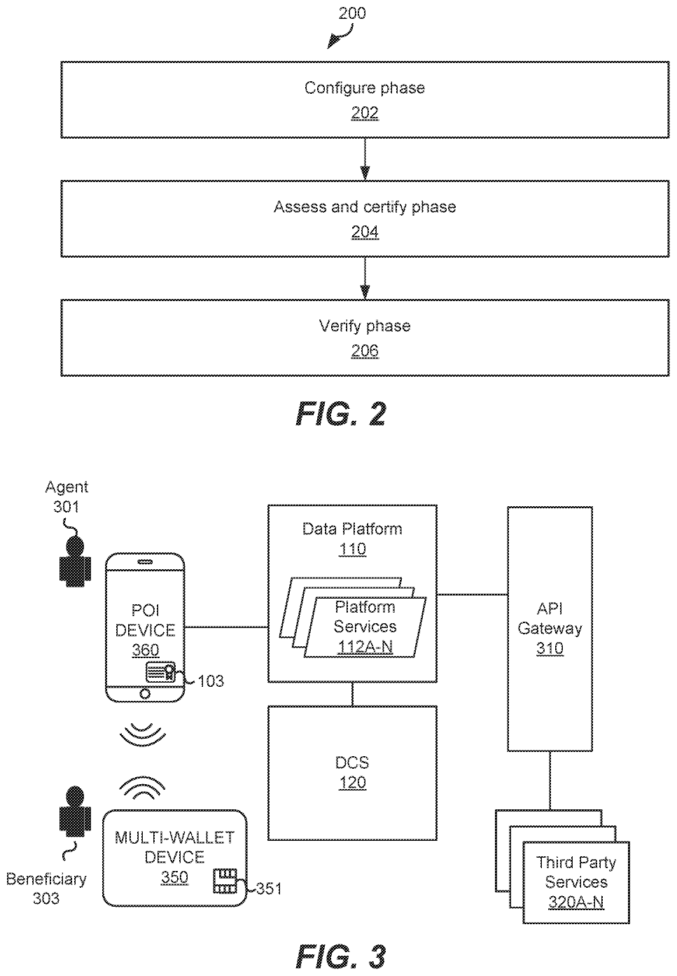

An example of device certification and use will now be described in the context of various phases. For example, FIG. 2 illustrates an example operation of the system in various phases 202, 204, and 206. During the configure phase 202, an administrator of a platform service (such as platform service 112 illustrated in FIG. 1) may configure various criteria for using the platform service. This configuration defines the available device capabilities against the objectives of the platform service 112. For example, an admin user may configure capability requirements and/or performance criteria thresholds for various operations (such as biometric performance, card taps, and so forth) needed in a platform application 164. One or more functions of the platform application 164 may be enabled or disabled based on the device capabilities 161, as reflected in the device certificate 103. In some examples, the configuration may also be generated automatically, based on the program objectives of a platform service 112.

During the assess and certify phase 204, the certification application 162 is installed on the device 160. The certification application 162 assesses the device capabilities 161 and performance benchmarks against the criteria, as reflected in the DCP 101. The certification application 162 facilitates “bring your own device” usage while maintaining minimum device capabilities and/or performance requirements. It should be noted that a subsequent device that is the same model as an already certified device need not be re-certified. For example, a device that was not directly certified may download a device certificate 103 for another device sharing the same model and/or other device parameters and the platform application 164 may use the device certificate 103 to enable or disable services. It should be further noted that if the device profile changes (such as having new software or an updated version of the model is available), then re-certification may be performed. Furthermore, if a DCP 101 is updated, then the device 160 may be re-certified. Thus, in some examples, the platform application 164 may check whether any updates (updates to the device 160, updates to the DCP 101, and/or other updates) necessitate re-certification and, if so, will download an updated DCP 101 if necessary, and initiate a recertification via the certification application 162.

During the verify phase 206, a platform application 164 may be installed at the device 160. For example, a user of the device 160 may download and execute (launch) the platform application 164. The platform application 164 may determine a device parameter such as a device model and download the corresponding device certificate 103 from the datastore 123 (via the DCS 120, which may be access through API calls to the API 128). It should be noted that in this example, the device 160 may be the same device that was tested to generate the device certificate 130 or may be another device that is the same model (or other device parameter) as a device that was previously tested. The platform application 164 may store the downloaded device certificate 103 locally at the device 160 to be evaluated to determine whether the device 160 is certified to access various platform services 112. Once the device certificate 103 is stored locally, the platform application 164 may enable or disable functions of the platform application 164 locally without a network connection. Thus, the device 160 may be enabled to perform the functions of the application even when a network connection is unavailable.

### Example System Implementation

The DCS 120 may be used in various contexts to certify a device 160 to enable access to services on the device. For example, FIG. 3 illustrates an example of an implementation of the system 100 in which platform services 112 are provided via point of interaction (POI) devices 360. In an example context, the platform services 112 may be provided by the data platform 110 to facilitate the provision of third-party services 320A-N to beneficiaries 303. Each third-party service 320 may include services across various domains including a humanitarian, education, agricultural, health, and/or other domains provided by a third-party provider. A third-party provider may interface with the data platform 110 via an API gateway 310 to facilitate provision of the third-party services 320A-N to the beneficiaries 303. In this sense, the data platform 110 may provide a technology platform through which various third-party providers provide their respective services. In this example, the platform services 112 may include operations that support the provision of the third-party services 320.

In some examples, the beneficiaries may be base of pyramid (BOP) users, who may be issued a multi-wallet device 350 by an operator of the data platform 110. BOP users refer to users that are socio-economically disadvantaged, especially in geographic regions where technology and financial services penetration is low. The beneficiary 303 may use the multi-wallet device 350 to gain access to the third-party services 320 facilitated by the data platform 110. The multi-wallet device 350 may be a chip-enabled device, such as a chipcard with an integrated circuit 351 that provides storage and processing capabilities in a card form factor. Other form factors may be used, but the card form factor may provide a cost-effective and robust solution for users in areas in which technology penetration is low, such as for BOP users. The storage and processing capabilities of the multi-wallet device may include storage and execution of multiple applications, including various mobile wallet applications that may each corresponding to a respective third-party service 320.

The POI device 360 may be operated by an agent 301 to communicate with the multi-wallet device 350. The agent 301 may work on behalf of a third-party provider, such as to provide third-party services 320 to the beneficiary 303 to which the multi-wallet device 350 was issued. Each agent 301 may use their own device for use as the POI device 360, facilitating a “bring your own device” (BYOD) implementation. While the BYOD implementation provides flexibility and reduced cost for the third-party providers, the variability in capabilities across different devices that different agents 301 may use makes it difficult to enforce technology requirements and constraints. Thus, a POI device 360 may be tested and certified. In this example, the POI device 360 is an example of the device 160 illustrated in FIG. 1.

The data platform 110 may provide various technology services to facilitate the provision of the third-party services 320. For example, each third-party provider may specify capability requirements and/or performance criteria that the POI device 360 should have to access the platform services 112 so that the agent 301 can provide third-party services to the beneficiary 303. A third-party service 320 may include the provision of humanitarian or other types of assistance to the beneficiary 303. A humanitarian assistance provider may require that the beneficiary 303 be authenticated before being provided with such assistance, such as to prevent fraud or theft. A platform service 112 may include computational functionality to monitor the provision of the third-party service 320. For example, the platform service 112 may include functionality to monitor a weekly provision of aid to the beneficiary 303, which may require biometric authentication of the beneficiary 303. Thus, to access this platform service 112, the POI device 360 may need to be capable of performing such biometric authentication. A POI device 360 not certified to perform biometric authentication may be unable to provide the platform service 112.

For example, a humanitarian organization may provide humanitarian assistance through its mobile wallet application stored on the multi-wallet device 350. An administrator of the humanitarian organization may specify one or more capability requirements and/or performance criteria of POI devices 360 used to facilitate humanitarian assistance to beneficiaries 303. The DCS 120 may generate a DCP 101 for based on the specified capability requirements and/or performance criteria. The POI device 360 may be certified to indicate its capabilities and/or satisfaction of performance criteria using the DCP 101. As such, the POI device 360 may use a device certificate 103 to enable or disable services on the POI device 360. An agent 301 may operate the POI device 360. An agent 301 may use the POI device 360 that was actually tested or may use a POI device 360 that is the same model as a device that was tested.

A beneficiary 303 may present a multi-wallet device 350 issued to the beneficiary 303 to receive the humanitarian assistance from an agent 301 of the humanitarian organization. The agent 301 may use the POI device 360 to communicate with the multi-wallet device 350. For example, the POI device 360 may interact with the multi-wallet device 350 via Near-Field Communication (NFC) and/or other way to communicate with the multi-wallet device 350. The POI device 360 may enable authentication services on the POI device 360 based on the device certificate 103.

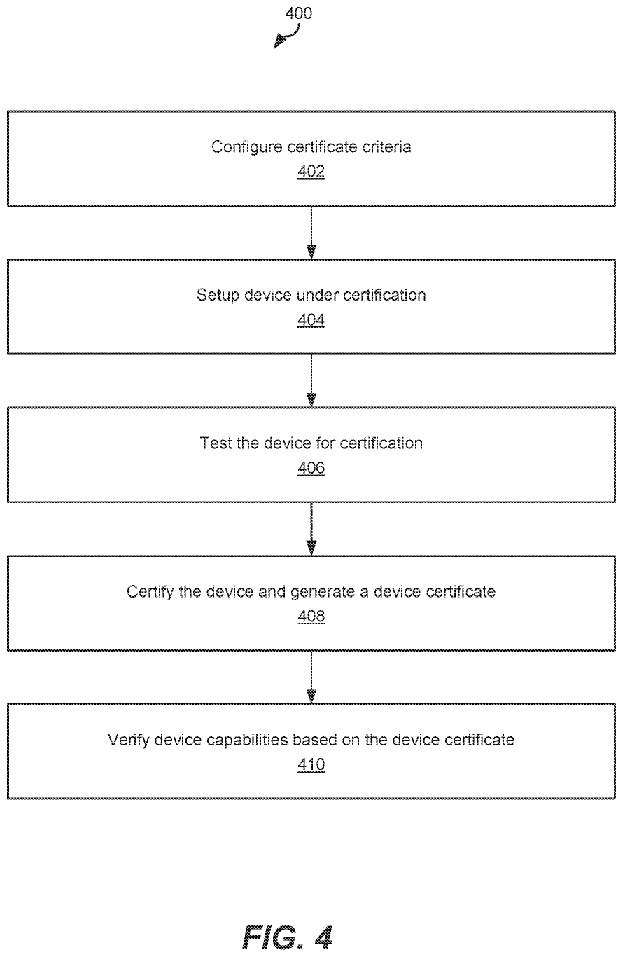

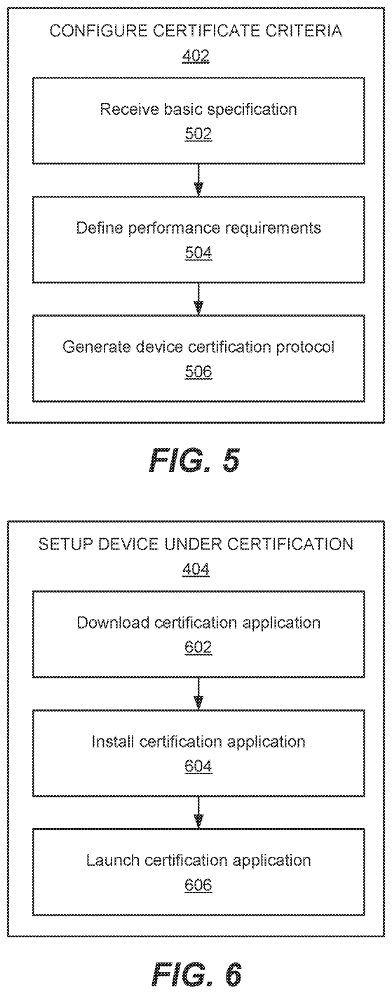

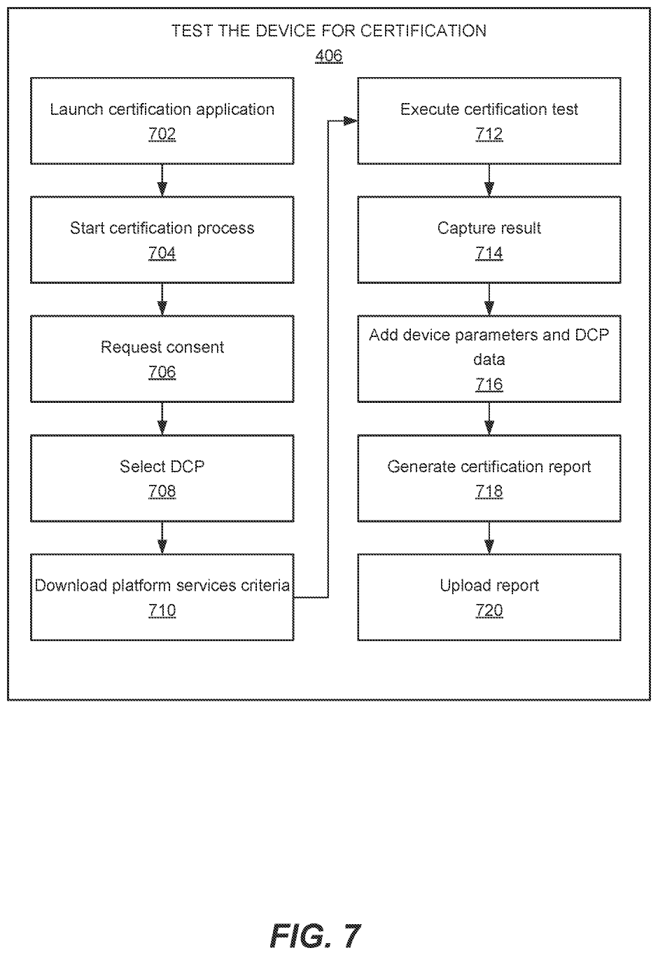

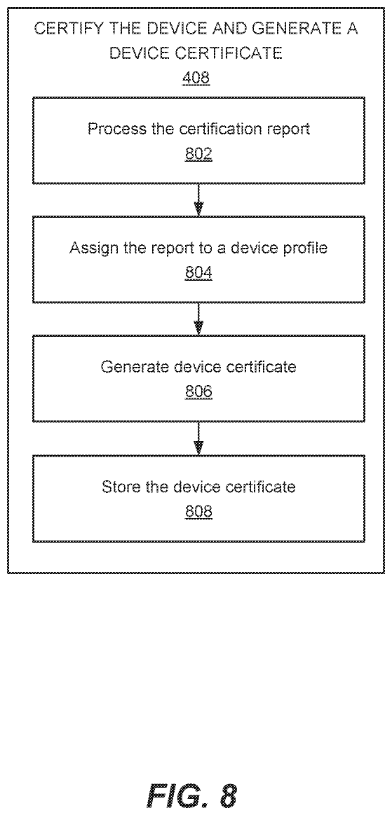

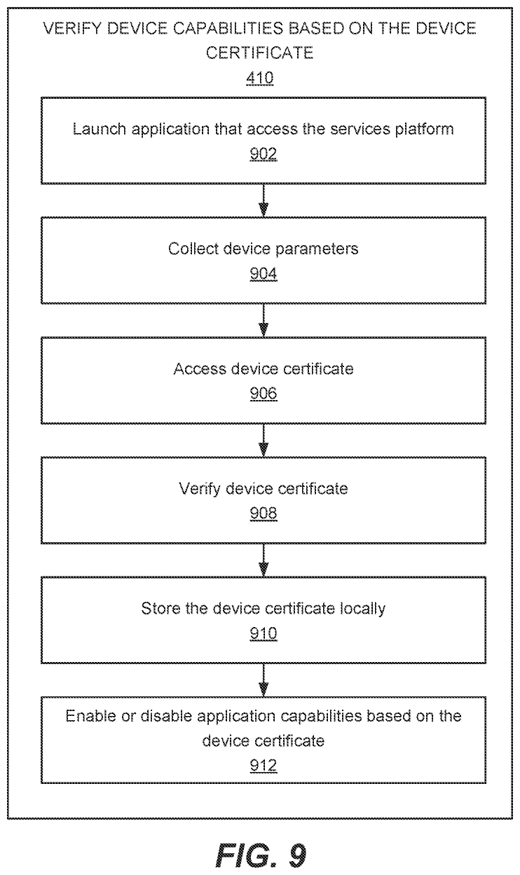

FIG. 4 illustrates an example of a method 400 of certifying a device (such as device 160) and accessing platform services based on a device certificate 103. At 402, the method 400 may include configuring certificate criteria. The certificate criteria may specify component requirements (such as hardware requirements) and/or performance requirements. An example of configuring certificate criteria is illustrated in FIG. 5. At 404, the method 400 may include setting up a device under certification (“DUC”). A DUC is a device that is being tested for certification. An example of setting up a DUC is illustrated in FIG. 6. At 406, the method 400 may include testing the DUC. An example of testing the DUC is illustrated in FIG. 7. At 408, the method 400 may include certifying the device and generating a device certificate. An example of certifying the device and generating a device certificate is illustrated in FIG. 8. At 410, the method 400 may include verifying the device capabilities based on the device certificate. An example of verifying the device capabilities based on the device certificate is illustrated in FIG. 9.

FIG. 5 illustrates an example of a method 402 of configuring certificate criteria. Such configuration may be based on user-specified input, such as through a portal or other interface that is programmed to receive the certificate criteria.

At 502, the method 402 may include receiving a basic specification that defines one or more hardware components to which the DUC should have access. In some examples, the DUC may have access to a hardware component when the hardware component is onboard (integrated with or otherwise housed within) the DUC. In some examples, the DUC may have access to a hardware component when the DUC is capable of using a hardware component remotely located (not integrated with the DUC).

At 504, the method 402 may include defining performance requirements. The performance requirements may relate to the basic specification. For example, a basic specification may require a processor and the performance requirement may specify that the processor is capable of performing a specified computation within a specified time limit. In another example, the basic specification may require an image capture device such as a camera and the performance requirement may specify that the camera capture a minimum resolution. In another example, the basic specification may require a biometric device such as a fingerprint scanner and the performance requirement may specify that the biometric device is able to accurately authenticate a certain number of biometric samples, which may include sample images (such as a fingerprint image) and/or live samples (such as a live fingerprint scan).

At 506, the method 402 may include generating a device certification protocol (DCP) based on the basic specification and/or the performance requirements. The DCP may be stored in association with one or more platform services. For example, a platform service may ensure that the device has the required components and/or performance as specified in the DCP, which is used to certify the device. A DCP may be identified by a DCP identifier (DCP ID). In some examples, a DCP may also be assigned with a user-friendly DCP name that may be more easily recognizable to a user than the DCP ID.

FIG. 6 illustrates an example of a method 404 of setting up a device under certification for testing. At 602, the method 404 may include downloading a certification application. For example, the DUC download the certification application. At 604, the method 404 may include installing the certification application. At 606, the method 404 may include launching the certification application. The certification application may include instructions that program a processor of the device to execute one or more testing functions.

For example, FIG. 7 illustrates an example of a method 406 of testing the device under certification. At 702, the method 406 may include launching the certification application. At 704, the method 406 may include starting the certification process.

At 706, the method 406 may include requesting consent to perform the testing. For example, requesting consent may include providing a prompt to confirm that the use of device components is permitted.

At 708, the method 406 may include selecting a DCP. The DCP may be selected based on user-input. For example, a user may select an appropriate DCP based on a DCP ID, DCP name, and/or other identifying information. In particular, a device may be certified to access a particular platform service, requirements for which may be encoded in the selected DCP.

At 710, the method 406 may include downloading platform services criteria for testing. The platform service criteria may include device component requirements and/or performance requirements that a device accessing the platform services should have. For example, the method 406 may include downloading the DCP, which includes the platform services criteria, that was selected at 708.

At 712, the method 406 may include executing the certification test. The certification test may assess whether the device complies with the platform service criteria, such as whether the requirements specified by the DCP are met. The certification test may test each requirement that is specified by the platform service criteria.

At 714, the method 406 may include capturing a result of the certification test. The result may include a result of a test to determine whether the device satisfies each requirement specified in the DCP. If there are multiple requirements, there may be multiple results corresponding to each requirement. In some examples, the result may include monitored performance metrics, such as a resolution of an image taken by a camera of the device, an amount of time the device took to complete a function, and/or other performance metric that is monitored in connection with the certification test.

At 716, the method 406 may include adding one or more device parameters and DCP data to the results. The device parameters may include a device identifier, a model identifier that identifies a model of the device, a manufacturer identifier that identifies a manufacturer of the device, a version number of the device, and/or other information about the device that was tested. The DCP data may include the DCP ID, DCP name, and/or other information about the DCP that was downloaded and used for testing.

At 718, the method 406 may include generating a certification report that includes the results. The certification report may therefore include results of the testing, including what was tested and its result, performance metrics of one or more of the testing, DCP data, and/or other information relating to the testing. At 720, the method 406 may include uploading the certification report, such as to the DCS 120.

FIG. 8 illustrates an example of a method 408 of certifying the device 160 and generating a device certificate 103. At 802, the method 408 may include processing the certification report. Such processing may include receiving the certification report from the device that was tested, parsing (obtaining and reading) the results, parsing the DCP identifier or other identifying information, and/or otherwise reading data from the certification report. At 804, the method 408 may include assigning the certification report to a device profile. The device profile may specify the model of the device.

At 806, the method 408 may include generating the device certificate, which includes an indication of the capabilities of the device. The capabilities may relate to the hardware, software, performance, and/or other capabilities that were tested. At 808, the method 408 may include storing the device certificate. The device certificate may be stored in association with a model identifier and/or other identifier for the device. For example, the device certificate may be applicable to all models of the device that was tested.

FIG. 9 illustrates an example of a method 410 of verifying device capabilities 161 based on the device certificate 103.

At 902, the method 410 may include launching an application that accesses a platform service. For example, application may relate to receiving a third-party service 320 and/or other functionality.

At 904, the method 410 may include collecting device parameters. At 906, the method 410 may include accessing the device certificate. At 908, the method 410 may include verifying the device certificate. For example, verifying the device certificate may include validating the digital signature used to digitally sign the device certificate. In a particular example, validating the digital signature may include using a public key of the DCS 120 to determine whether the DCS digitally signed the device certificate with a private key of the DCS.

At 910, the method 410 may include storing the device certificate locally. At 912, the method 410 may include enabling or disabling one or more application capabilities based on the device certificate. For example, enabling or disabling one or more application capabilities may include enabling or disabling biometric authentication features if the device certificate indicates that the device lacks or biometric sensor or has a biometric sensor that is inadequate. Other application capabilities may be enabled or disabled. Based on enabled or disabled capabilities, the device may be authorized or prevented from accessing certain services. For example, if the biometric authentication capability is disable, then the device may be unable to access platform services that require biometric authentication. It may be possible that the device is able to access other platform services that do not require biometric authentication. For example, some payment transactions may require biometric authentication while other payment transactions may accept secret password entry or chip-based authentication. The device may be unable to participate in payment transactions that require biometric authentication but may be able to participate in payment transactions that accept secret password entry.

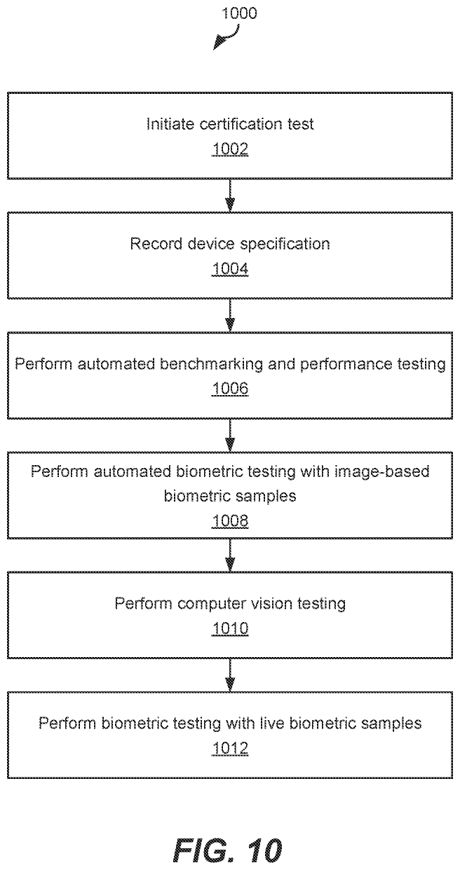

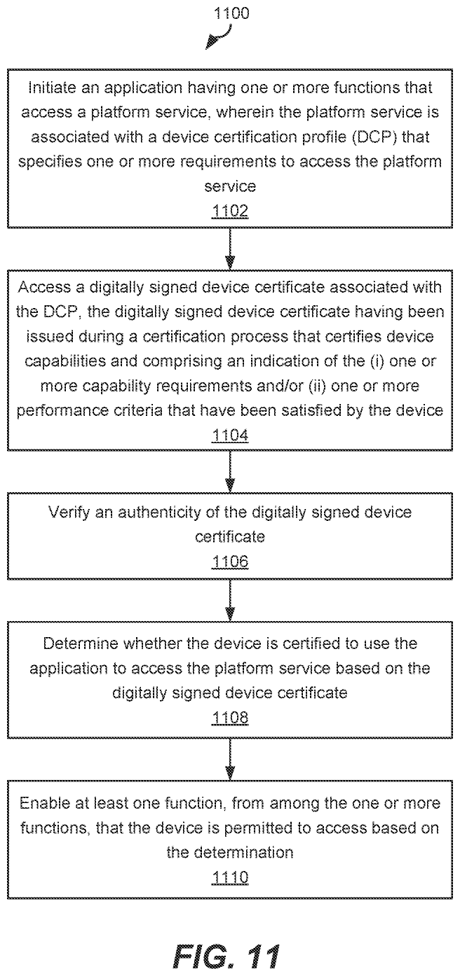

FIG. 10 illustrates an example of a method 1000 of testing onboard hardware using performance metrics for a device under certification. At 1002, the method 1000 may include initiating a certification test.

At 1004, the method 1000 may include recording a device specification, which may include a device parameter. At 1006, the method 1000 may include performing automated benchmarking and performance testing, examples include 1008-1012 that follow.

At 1008, the method 1000 may include performing automated biometric testing with image-based biometric samples. For example, the image-based biometric samples may include a target sample image and a test sample image. The target sample image may be an image of an authentic biometric signature, such as an image of a fingerprint, face, iris, and/or other biometric feature. The test sample image may include real or faked (impostor) images biometric features that are tested against the target sample image. The test sample image may be read by a biometric sensor such as a fingerprint reader or camera to determine whether the biometric sensor is able to correctly authenticate or invalidate the test sample. This may be repeated for multiple target sample image and test sample image pairs.

At 1010, the method 1000 may include perform computer vision testing. Computer vision testing may include assessing the performance of an image sensor such as a camera of the DUC. For example, computer vision testing may include a printed card-based test in which the image sensor takes an image of a printed card having printed features. The computer vision testing may assess whether the image sensor is able to take sufficient resolution images to identify these printed features. The printed features may include different colors, shading, patterns, and/or other features that may be used to assess the resolution or other performance of the image sensor.

At 1012, the method 1000 may include assessing performance based on live matching. This performance testing may include testing similar to 1008 and 1010 except that live subjects may be used instead of test subjects or the card-based test.

FIG. 11 illustrates an example of a method 1100 of accessing services based on a device certificate 103. At 1102, the method 1100 may include initiating an application (such as a platform application 164) having one or more functions that access a platform service 112. The platform service may be associated with a device certification profile (DCP 101) that specifies one or more requirements to access the platform service. The one or more requirements may include (i) one or more capability requirements and/or (ii) one or more performance criteria.

At 1104, the method 1100 may include accessing a digitally signed device certificate 103 associated with the DCP. The digitally signed device certificate may have been issued during a certification process that certifies device capabilities 161. The digitally signed device certificate may include an indication of the (i) one or more capability requirements and/or (ii) one or more performance criteria that have been satisfied by the device.

At 1106, the method 1100 may include verifying an authenticity of the digitally signed device certificate. For example, verifying the authenticity may include decrypting the digitally signed device certificate with a public key of the signing authority, such as the DCS 120 that issued and digitally signed the device certificate. At 1108, the method 1100 may include determining whether the device is certified to use the application to access the platform service based on the digitally signed device certificate.

At 1110, the method 1100 may include enabling at least one function, from among the one or more functions, that the device is permitted to access based on the determination of whether the device is certified to use the application to access the platform service. The at least one function may require (at least as specified by an admin user that uploaded the requirements) the one or more capability requirements and/or (ii) one or more performance criteria that have been satisfied by the device.

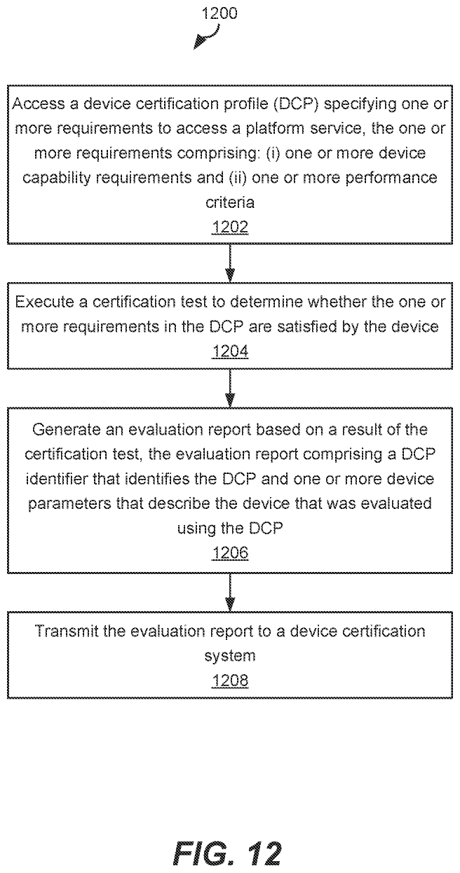

FIG. 12 illustrates an example of a method 1200 of certifying a device 160. At 1202, the method 1200 may include

At 1202, the method 1200 may include accessing a device certification profile (DCP 101) specifying one or more requirements to access a platform service 112. The one or more requirements may include (i) one or more device capability requirements and/or (ii) one or more performance criteria. At 1204, the method 1200 may include executing a certification test to determine whether the one or more requirements in the DCP are satisfied by the device.

At 1206, the method 1200 may include generating, by the device, an evaluation report based on a result of the certification test. The evaluation report may include a DCP identifier that identifies the DCP and one or more device parameters that describe the device that was evaluated using the DCP. At 1208, the method 1200 may include transmitting the evaluation report to a device certification system (DCS 120).

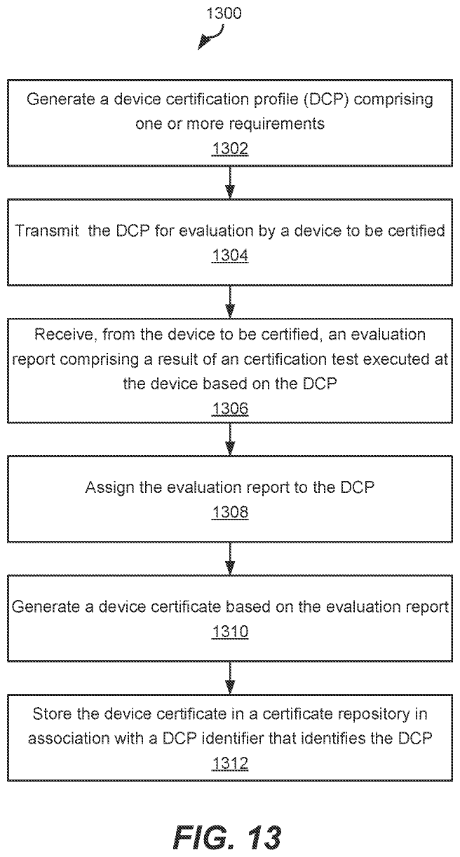

FIG. 13 illustrates an example of a method 1300 of generating a device certificate 103. At 1302, the method 1300 may include generating a device certification profile (DCP 101) comprising one or more requirements. The one or more requirements may include a device capability requirement and/or a performance criterion. At 1304, the method 1300 may include transmitting the DCP for evaluation by a device (such as device 160) to be certified.

At 1306, the method 1300 may include receiving, from the device to be certified, an evaluation report comprising a result of an certification test executed at the device based on the DCP. At 1308, the method 1300 may include assigning the evaluation report to the DCP. For example, the DCP may be stored in association with the evaluation report. At 1310, the method 1300 may include generating a device certificate based on the evaluation report. At 1312, the method 1300 may include storing the device certificate in a certificate repository in association with a DCP identifier that identifies the DCP.

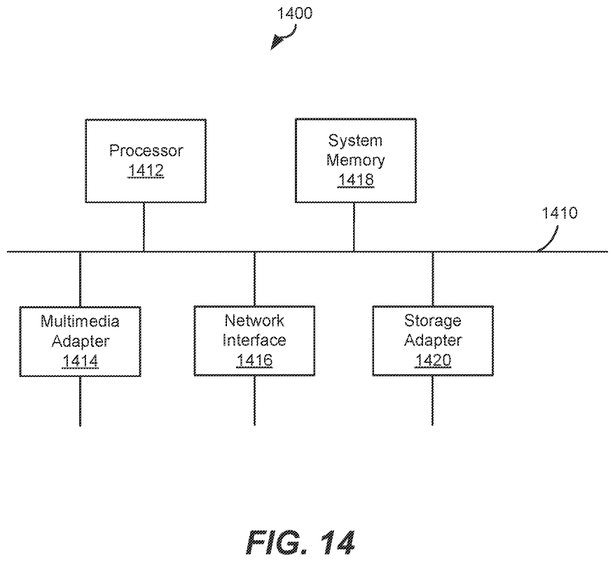

FIG. 14 illustrates an example of a computer system 1400 that may be implemented by devices illustrated in FIGS. 1 and 3. The computer system 1400 may be part of or include the system 100 to perform the functions and features described herein. For example, various ones of the devices of system 100 may be implemented based on some or all of the computer system 1400.

The computer system 1400 may include, among other things, an interconnect 1410, a processor 1412, a multimedia adapter 1414, a network interface 1416, a system memory 1418, and a storage adapter 1420.

The interconnect 1410 may interconnect various subsystems, elements, and/or components of the computer system 1400. As shown, the interconnect 1410 may be an abstraction that may represent any one or more separate physical buses, point-to-point connections, or both, connected by appropriate bridges, adapters, or controllers. In some examples, the interconnect 1410 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 1410 may allow data communication between the processor 1412 and system memory 1418, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 1412 may control operations of the computer system 1400. In some examples, the processor 1412 may do so by executing instructions such as software or firmware stored in system memory 1418 or other data via the storage adapter 1420. In some examples, the processor 1412 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 1414 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 1416 may provide the computer system 1400 with an ability to communicate with a variety of remote devices over a network such as a communication network. The network interface 1416 may include, for example, an Ethernet adapter, a Fibre Channel adapter, and/or other wired- or wireless-enabled adapter. The network interface 1416 may provide a direct or indirect connection from one network element to another, and facilitate communication and between various network elements.

The storage adapter 1420 may connect to a standard computer readable medium for storage and/or retrieval of information, such as a fixed disk drive (internal or external).

Other devices, components, elements, or subsystems (not illustrated) may be connected in a similar manner to the interconnect 1410 or via a network such as a communication network. The devices and subsystems can be interconnected in different ways from that shown in FIG. 9. Instructions to implement various examples and implementations described herein may be stored in computer-readable storage media such as one or more of system memory 1418 or other storage. Instructions to implement the present disclosure may also be received via one or more interfaces and stored in memory. The operating system provided on computer system 1400 may be MS-DOS®, MS-WINDOWS®, OS/2®, OS X®, IOS®, ANDROID®, UNIX®, Linux®, or another operating system.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “112A-N” does not refer to a particular number of instances of 130, but rather “one or more.”

The APIs described herein (such as the API 128 and API gateway 310) may be implemented using a RESTful (REST) Application Programming Interface (API), a Simple Object Access Protocol (SOAP) interface, and/or other type of interface that may provide an interface to a remote computer. The datastore 123 may include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A device for accessing platform services based on a device certificate, the device comprising:
a processor programmed to:
initiate an application having one or more functions that access a platform service, wherein the platform service is associated with a device certification profile (DCP) that specifies one or more requirements to access the platform service, the one or more requirements comprising: (i) one or more capability requirements and/or (ii) one or more performance criteria;
access a digitally signed device certificate associated with the DCP, the digitally signed device certificate having been issued during a certification process that certifies device capabilities and comprising an indication of the (i) one or more capability requirements and/or (ii) one or more performance criteria that have been satisfied by the device;
verify an authenticity of the digitally signed device certificate;
determine whether the device is certified to use the application to access the platform service based on the digitally signed device certificate; and
enable at least one function, from among the one or more functions, that the device is permitted to access based on the determination of whether the device is certified to use the application to access the platform service, the at least one function requiring the one or more capability requirements and/or (ii) one or more performance criteria that have been satisfied by the device.

2. The device of claim 1, wherein the processor is further programmed to:
determine a device model;
identify the DCP based on the device model; and
identify the digitally signed certificate based on the identified DCP.

3. The device of claim 1, further comprising a memory that locally stores the digitally signed device certificate for offline validation.

4. The device of claim 1, wherein the processor is further programmed to:
permit access to the at least one function; and
execute the at least one function to access a corresponding feature of the platform service.

5. The device of claim 1, wherein the processor is further programmed to:
identify at least a second function, from among the one or more functions, that the device is not permitted to access because the device does not have a capability required by the second function as defined in the DCP and recorded in the device certificate; and
disable access to the second function.

6. The device of claim 1, wherein the digitally signed device certificate is based on a certification of a device model and wherein the device receives the digitally signed device certificate based on a determination that a model of the device matches the device model.

7. A method of certifying a device, comprising:
accessing, by the device, a device certification profile (DCP) specifying one or more requirements to access a platform service, the one or more requirements comprising: (i) one or more device capability requirements and/or (ii) one or more performance criteria;
executing, by the device, a certification test to determine whether the one or more requirements in the DCP are satisfied by the device;
generating, by the device, an evaluation report based on a result of the certification test, the evaluation report comprising a DCP identifier that identifies the DCP and one or more device parameters that describe the device that was evaluated using the DCP; and
transmitting, by the device, the evaluation report to a device certification system.

8. The method of claim 7, further comprising:
receiving, by the device, a digitally signed device certificate from the device certification system that is to assess the evaluation report and generate the digitally signed device certificate based on the assessment.

9. The method of claim 8, further comprising:
storing the digitally signed device certificate in a memory of the device for later retrieval.

10. The method of claim 7, wherein the one or more requirements comprises an image capture device requirement and a performance requirement comprises an image quality requirement, and wherein executing the test comprises:
testing an onboard image capture device against a benchmark metric.

11. The method of claim 10, wherein the benchmark metric comprises a biometric matching metric to determine whether the onboard image capture device is able to generate an image quality capable of performing biometric authentication.

12. The method of claim 10, wherein the benchmark metric comprises a biometric matching metric to determine whether the onboard image capture device is able to generate an image quality capable of performing biometric authentication.

13. The method of claim 7, wherein the one or more requirements comprises a communication device requirement that requires that the device is able to participate via a specified communication protocol, and wherein executing the test comprises:
testing an onboard communication device to determine whether the device is able to participate via the specified communication protocol.

14. The method of claim 13, wherein testing the onboard communication device comprises:
determining whether the onboard communication device is able to communicate with a Near-Field Communication (NFC) tag.

15. The method of claim 7, further comprising:
monitoring, during the certification test, one or more performance metrics during the test, wherein the one or more performance metrics is included in the generated evaluation report.

16. The method of claim 15, wherein monitoring the one or more performance metrics comprising:
determining a consumption of one or more computational resources during the evaluation test.

17. The method of claim 15, wherein monitoring the one or more performance metrics comprising:
obtaining a biometric capture quality during the evaluation test.

18. The method of claim 15, wherein monitoring the one or more performance metrics comprising:
determining whether there is support for liveness detection during an image capture.

19. A non-transitory computer readable medium storing instructions for generating a device certificate, the instructions, when executed by a processor, program the processor to:
generate a device certification profile (DCP) comprising one or more requirements;
transmit the DCP for evaluation by a device to be certified;
receive, from the device to be certified, an evaluation report comprising a result of an certification test executed at the device based on the DCP;
assign the evaluation report to the DCP;
generate a device certificate based on the evaluation report; and
store the device certificate in a certificate repository in association with a DCP identifier that identifies the DCP.

20. The non-transitory computer readable medium of claim 19, wherein the instructions, when executed by the processor, further programs the processor to:
receive a request for the device certificate in connection with a device that accesses one or more platform services;
transmit the device certificate responsive to the request.
